(19) United States
(12) Patent Application Publication
(10) Pub. No.: US 2021/0200859 A1
(43) Pub. Date: Jul. 1, 2021

(54) MALWARE DETECTION BY A SANDBOX SERVICE BY UTILIZING CONTEXTUAL INFORMATION

(71) Applicant: Fortinet, Inc., Sunnyvale, CA (US)

(72) Inventors: Udi Yavo, Herzlia (IL); Roy Katmor, San Francisco, CA (US); Ido Kelson, Tel-Aviv (IL)

(73) Assignee: Fortinet, Inc., Sunnyvale, CA (US)

(21) Appl. No.: 16/731,291

(22) Filed: Dec. 31, 2019

(51) Int. Cl. G06F 21/53; G06F 21/56

(52) U.S. Cl. CPC G06F 21/53; G06F 2221/034; G06F 21/56

(57) ABSTRACT

Systems and methods for improving malware detection by a sandbox service by utilizing Endpoint Detection and Response (EDR) origin contextual information are provided. According to an embodiment, a sandbox service associated with a network security platform protecting an enterprise network receives a file associated with sandbox-evading malware, to be classified by the sandbox service, and contextual information related to the file. The file is received from an endpoint security solution of the network security platform running on an endpoint device of the enterprise network. The sandbox service classifies the file as being malware by detonating the sandbox-evading malware as a result of performing sandboxing on the file including emulating an environment of the endpoint device based on the contextual information.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2019, Fortinet, Inc.

### BACKGROUND

### Field

Embodiments of the present invention generally relate to network security and security event detection. In particular, embodiments of the present invention relate to improving malware detection by a sandbox service, including detection of sandbox-evading malware, by providing the sandbox service with Endpoint Detection and Response (EDR) contextual information, including origin environment parameters.

### Description of the Related Art

To curb cyberattacks and threats, efficient pre-execution threat prevention technologies and post-execution prevention technologies have been developed. Pre-execution prevention technologies attempt to block known and file-based attacks and post-execution prevention technologies attempt to detect and block advanced attacks in real-time. One type of threat prevention technology that can be used in connection with pre-execution prevention and/or post-execution prevention involves submitting a file at issue to a sandbox service that performs sandboxing. Sandboxing refers to a safe isolated testing environment that replicates an end user operating environment where code or an executable file can be executed and analyzed to determine how the code or the executable behaves. Sandboxing can be useful in testing and blocking unverified software programs that may contain embedded malicious code.

However, as malware becomes more sophisticated, multiple sandbox evasion techniques, such as delaying execution of malicious code, fingerprinting hardware, detecting the CPU core count, detecting if there is any user interaction (e.g., mouse/trackpad movement or keyboard entry), environment detection and the like, are being used by malware to avoid detonation when operating in a sandbox environment. Such evasion tactics may result in malware avoiding detection by sandboxing services.

Therefore, in view of the foregoing, there is a need in the art for improved sandboxing techniques to detect sandbox-evading malware.

### SUMMARY

Systems and methods are described for improving malware detection by a sandbox service by utilizing Endpoint Detection and Response (EDR) origin contextual information. According to an embodiment, a sandbox service associated with a network security platform protecting an enterprise network receives a file associated with sandbox-evading malware, to be classified by the sandbox service, and contextual information related to the file. The file is received from an endpoint security solution of the network security platform running on an endpoint device of the enterprise network. The sandbox service classifies the file as being malware by detonating the sandbox-evading malware as a result of performing sandboxing on the file including emulating an environment of the endpoint device based on the contextual information.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A-B illustrate network architectures in which aspects of the present invention can be implemented in accordance with an embodiment of the present invention.

FIG. 2 is a block diagram illustrating functional components of a sandbox service in accordance with an embodiment of the present invention.

FIG. 3 is a flow diagram illustrating a process performed by a sandbox service in accordance with an embodiment of the present invention.

FIG. 4 illustrates an exemplary computer system in which or with which embodiments of the present invention may be utilized.

### DETAILED DESCRIPTION

Systems and methods are described for improving malware detection by a sandbox service by utilizing Endpoint Detection and Response (EDR) origin contextual information. In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The phrases “endpoint protection platform” or “endpoint security solution” generally refer to cybersecurity monitoring and/or protection functionality implemented on an endpoint device. In one embodiment, the endpoint protection platform can be deployed in the cloud or on-premises and supports multi-tenancy. The endpoint protection platform may include a kernel-level Next Generation AntiVirus (NGAV) engine with machine learning features that prevent infection from known and unknown threats and may leverage code-tracing technology to detect advanced threats such as in-memory malware. The endpoint protection platform may be deployed on the endpoint device in the form of a lightweight endpoint agent that utilizes less than one percent of CPU and less than 100 MB of RAM and may leverage, among other things, various security event classification sources provided within an associated cloud-based security service. Non-limiting examples of an endpoint protection platform include the Software as a Service (SaaS) enSilo Endpoint Security Platform and the FORTICLIENT integrated endpoint protection platform available from Fortinet, Inc. of Sunnyvale, Calif.

The term “event” generally refers to an action or behavior of a process. Non-limiting examples of events include filesystem events and operating system events. In various embodiments described herein, certain events detected on an endpoint device by an endpoint protection solution running on the endpoint device may trigger the endpoint protection solution to have a file classified by a sandboxing service. Events need not be suspicious to trigger the use of the sandboxing service. For example, as part of a pre-execution threat prevention process, a mere attempt to execute a file may trigger use of the sandboxing service. Alternatively or additionally, as part of a post-execution threat prevention process, detection of an event initially classified as suspicious or malicious by the endpoint protection solution may trigger use of the sandboxing service. Events that may be initially classified as suspicious or malicious by a heuristic engine and/or a machine-learning engine employed by the endpoint protection platform, for example, may include an attempt to communication with a critical software vulnerability (CVE), an attempt to access the registry of the operating system, the network or the file system, an attempt by the process to copy itself into another process or program (in other words, a classic computer virus), an attempt to write directly to the disk of the endpoint device, an attempt remain resident in memory after the process has finished executing, an attempt to decrypt itself when run (a method often used by malware to avoid signature scanners), an attempt to binds to a TCP/IP port and listen for instructions over a network connection (this is pretty much what a bot—also sometimes called drones or zombies—do), an attempt to manipulate (copy, delete, modify, rename, replace and so forth) files that are associated with the operating system, an attempt to read the memory of sensitive programs, an attempt to hook keyboard or mouse (a/k/a keylogging), an attempt capture a screen shot, an attempt to record sounds, and/or other behaviors or actions that may be similar to processes or programs known to be malicious. In one embodiment, events may be detected or intercepted by the endpoint protection platform hooking filesystem and/or operating system application programming interface (API) calls of interest and/or by leveraging a hypervisor to monitor the operating system.

The phrase “contextual information” generally refers to information related to the circumstances in which an event occurred. Non-limiting examples of contextual information for a file or a process associated with an event includes command line information (e.g., command line instruction(s) and associated parameters) associated with the execution of a process or an attempt to execute a file, a process execution chain (e.g., a stack trace), a memory dump associated with the process or file, information indicative of an application with which the process or file is associated, information identifying the user, computer name, domain name, geographical location (based on IP), operating system type, the file name used for execution, related Dynamic Link Library (DLL) files, environment variables associated with the process or the file, and the like.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but are not limited to, simple packet forwarding, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

The phrases “network security device” or “security device” generally refer to a hardware or virtual device or network appliance that provides security services to a private network, for example, providing one or more of data privacy, protection, encryption and security. A network security device can be a device providing one or more of the following features: network firewalling, VPN, antivirus, intrusion prevention (IPS), content filtering, data leak prevention, anti-spam, antispyware, logging, reputation-based protections, event correlation, network access control, vulnerability management, load balancing and traffic shaping—that can be deployed individually as a point solution or in various combinations as a unified threat management (UTM) solution. Non-limiting examples of network security devices include proxy servers, firewalls, VPN appliances, gateways, UTM appliances and the like.

The phrases “security event classification source” or “data feed” generally refer to a security service in the form of hardware, software or a combination thereof that is capable of contributing in whole or in part to a classification result for a given security event (e.g., as malicious, suspicious, a potentially unwanted program (PUP), inconclusive, likely safe or safe). Non-limiting examples of security event classification sources include various types of endpoint protection platforms/solutions, antivirus engines, static malware analysis engines, dynamic malware analysis engines, memory forensic engines, sandboxes, User and Entity Behavior Analytics (UEBA), Intrusion Detection Systems (IDSs), content inspection engines, distributed denial of service (DDoS) mitigation engines, machine-learning classifiers, file threat-feeds, Internet Protocol (IP)/uniform resource locator (URL) threat feeds, Indicators of compromise (IOC) threat feeds, file reputation services, IP/URL reputation services, vulnerability discovery services, Tactics Techniques and Procedures (TTPs) feeds, security events collected from another private network, EDR data, and the like. In one embodiment, some security event classification sources may be limited to classifying one or more specific artifacts of a given security event, while others may be capable of independently classifying a given security event and producing a classification result. For example, a hash feed that generates a hash of a file associated with an event may be capable of classifying the file and an IP or URL feed (e.g., an IP/URL threat feed or an IP/URL reputation service) may be capable of classifying an IP address or a URL associated with an event.

The phrase “network security platform” generally refers to one or more security event classification sources that are used to protect a private network. The security event classification sources of a network security platform may have knowledge of each other, communicate with each other, cooperate with each other to facilitate classification of observed security events and otherwise create synergies and improve the overall protection provided to the private network against cybersecurity threats. Alternatively or additionally, the security event classification sources participating within a network security platform may be under common control of a management service or device. A network security platform may include security event classification sources from the same or different parties (e.g., manufacturers and/or service providers) and the participating security event classification sources may reside or operate within different computing environments. For example, some of the participating security event classification sources may be implemented in physical form as part of an on premises solution and others may be implemented as services or in virtual form within a cloud-based environment (e.g., a cloud-base security service (e.g., the enSilo Cloud Service or FORTIGUARD security services available from the assignee of the present invention) or within a third-party cloud provider). Non-limiting examples of a network security platform include one or more network security devices and/or endpoint protection platforms that are part of a cooperative security fabric (e.g., the Fortinet Security Fabric) and one or more network security services implemented within a cloud-based security service or other public, private or hybrid cloud environment. While in the context of various examples described herein, for sake of simplicity and brevity, a network security platform is described as including an endpoint protection platform running on an endpoint device of a private network and a sandbox service, those skilled in the art will appreciate embodiments of the present invention are applicable to network security platforms including more and/or different security event classification sources.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While embodiments of the present invention have been illustrated and described, it will be clear that the invention is not limited to these embodiments. Numerous modifications, changes, variations, substitutions, and equivalents will be apparent to those skilled in the art, without departing from the spirit and scope of the invention, as described in the claims.

According to various embodiments of the present invention, a sandbox service associated with a network security platform protecting an enterprise network, including a variety of end-point devices, receives a file that is associated with sandbox-evading malware, to be classified by the sandbox service, and contextual information related to the file. The file is received from an endpoint security solution of the network security platform running on an endpoint device of the enterprise network. The sandbox service classifies the file as being malware by detonating the sandbox-evading malware as a result of performing sandboxing on the file including emulating an environment of the endpoint device based on the contextual information.

Various embodiments of the present invention enrich a generic sandbox service (e.g., a sandbox service implemented in a cloud-based security service or a sandbox appliance residing within the same private network as an endpoint device) with Endpoint Detection and Response (EDR) origin contextual information to facilitate recognition of sandbox-evading malware. In order for the sandbox service to more closely emulate the circumstances and environment in which an event associated with sandbox-evading malware observed by the endpoint protection platform was triggered on the endpoint device, in one embodiment, a fulsome set of the EDR origin contextual information is captured by the endpoint protection platform and communicated to the sandbox service. In one embodiment, the EDR origin contextual information includes one or more of command line information (e.g., command line instruction(s) and associated parameters) associated with the execution of the process, a process execution chain, a memory dump associated with the process, information indicative of an application with which the process is associated, information identifying the user, environment variables associated with the process and the like.

In an example, the sandbox service may receive a file associated with the sandbox-evading malware along with contextual information related to the file. The sandbox-evading malware may be detonated by performing sandboxing on the file along with emulating an environment as per the received contextual information. Based on the detonation the file associated with the sandbox-evading malware may be classified as malware.

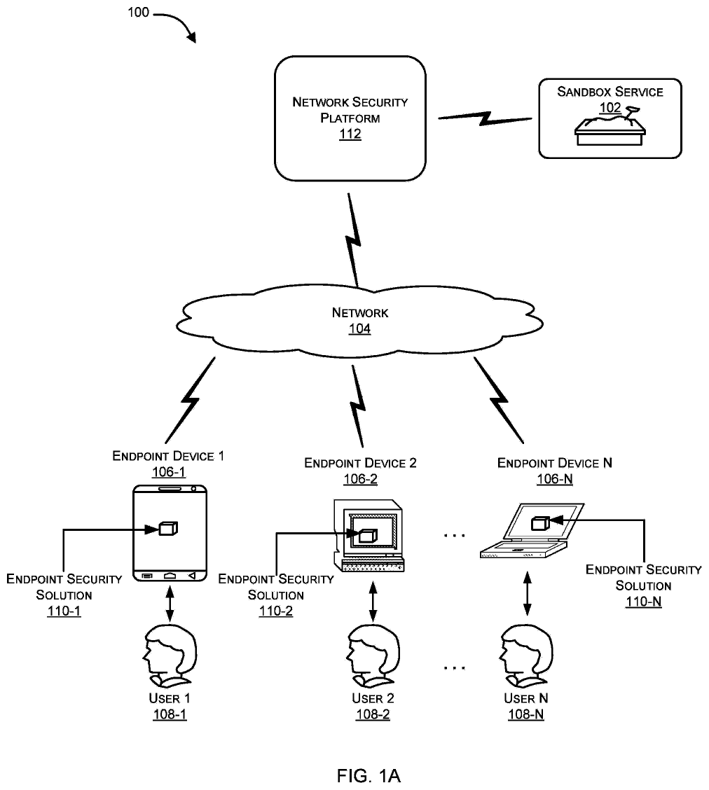

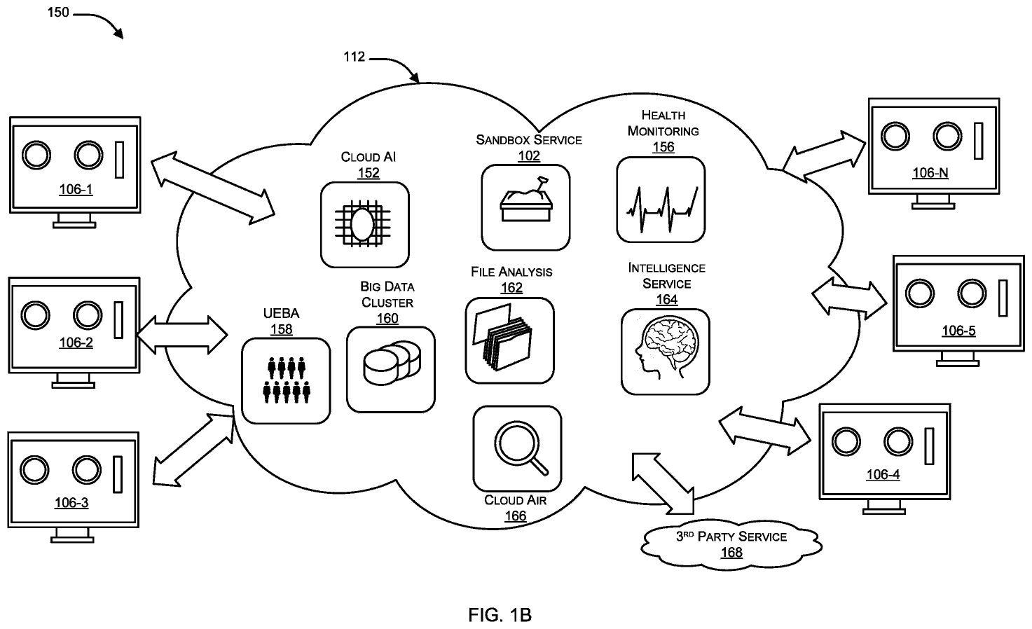

FIGS. 1A-B illustrate network architectures 100 and 150 in which aspects of the present invention can be implemented in accordance with an embodiment of the present invention. Referring to architectures 100 and 150, a cloud-based network security platform 112 that implements a sandbox service 102, protects an enterprise network 104 including multiple endpoint devices 106-1, 106-2 . . . 106-N (which may be collectively referred to herein as endpoint devices 106 and which may be individually referred to herein as an endpoint device 106). Users 108-1, 108-2 . . . 108-N (may be collectively referred to as users 108 and individually as a user 108, hereinafter) of network 104 can interact with endpoint devices 106, which may include, but are not limited to, personal computers, smart devices, web-enabled devices, hand-held devices, laptops, mobile devices (e.g., smartphones), and the like.

Those skilled in the art will appreciate that, network 104 in architecture 100 can be a wireless network, a wired network or a combination thereof that can be implemented as one of the different types of networks, such as an Intranet, a Local Area Network (LAN), a Wide Area Network (WAN), Internet, and the like. Further, the network can either be a dedicated network or a shared network. A shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

In addition to sandbox service 102, security platform 112 may include one or more other functional components such as, including, for example, cloud based Artificial Intelligence (AI) 152, a User and Entity Behavior Analytics (UEBA) service 158, big data cluster 160, a file analysis service 162, a cloud-based Automated Incidence Response and Remediation (AIR) service, a health monitoring service 156, and an intelligence service 164. The functional components of security platform 112 along with third-party services 168 may facilitate proactive, real-time and fully automated security with endpoint devices 106 through a single integrated platform.

According to an embodiment, endpoint security solutions 110-1, 110-2, . . . , 110-N (which may be collectively referred to as endpoint security solutions 110 and may be individually referred to as an endpoint security solution 110, hereinafter) running on corresponding endpoint devices 106 may perform endpoint security analysis to detect whether endpoint device 106 has potentially been infected by malware. In one embodiment, the endpoint security solution 110 may determine the endpoint device 106 has potentially been infected with malware as a result of observing an event associated with a process running on the endpoint device 106 that is initially classified by the endpoint security solution 110 as suspicious, malicious, or a potentially unwanted program (PUP).

Responsive to determining that endpoint device 106 has potentially been infected by software-evading malware, endpoint security solution 110 may transmit a file associated with sandbox-evading malware from endpoint device 106 to security platform 112 running sandbox service 102 along with contextual information related to the file, captured by the endpoint security solution 110. In one implementation, security platform 112 may be a cloud-based network security service running sandbox service 102, which can be implemented as a physical or virtual sandbox appliance. In alternative embodiments, the sandbox service 102 may be provided by a sandbox appliance residing in the enterprise network in the form of on-premises equipment.

According to an embodiment, sandbox service 102 receives the file associated with the sandbox-evading malware from endpoint security solution 110 running on endpoint device 106, and a corresponding set of contextual information related to the file. Sandbox service 102 classifies the file as being malware by detonating the sandbox-evading malware. The detonation is done by performing sandboxing on the file including emulating an environment of the endpoint device 106 based on the provide contextual information.

In one embodiment, the contextual information related to the file is captured by the endpoint security solution 110 in response to detection of a suspicious or malicious event that relates to a process, running on the endpoint device 106, associated with the file. The contextual information related to the file may include command line information associated with the process, an execution chain associated with the process, a memory dump associated with the process, information indicative of an application with which the process is associated, information identifying an end user associated with the process, or environment variables associated with the process. The suspicious or malicious event may be associated with a process that was initiated on the endpoint device 106 as a result of the end user downloading and opening a file from the Internet via a web browser, opening a file received via email, visiting a compromised website or a website otherwise hosting malicious content, delayed or latent execution by a previously installed dropper, or use of an infected word processing document. Non-limiting examples of sandbox-evading malware include Shamoon, Grobios, GootKit, ZeuS Panda, Heodo, QakBot Trojan, Kovter, Locky, and Nymaim. These examples are briefly described below to illustrate various sandbox evasion techniques.

Shamoon was discovered in 2012. In order to evade sandboxing, this virus was programmed to execute its logic bomb at a certain date and time.

Grobios was found in 2018 being delivered via the RIG Exploit Kit (EK) from various compromised domains, which had a malicious iframe injected to it. The iframe loads a malvertisement domain, which communications over SSL and leads to the RIG EK landing page that loads the malicious Flash file, which when opened drops the Grobios Trojan. Grobios uses various techniques to evade detection. For example, before connecting to the command and control (C&C), it performs a series of checks to detect the VM and malware analysis environment.

GootKit is an advanced banking Trojan that was discovered in 2014. Checks for virtual machine (VM) values take place at the dropper phase before GootKit's payload is deployed. Among other things, the dropper verifies the system's processor value inside the Windows Registry and checks for VM resources on disk and for additional specific values in the Registry.

Zeus Panda is another banking Trojan. Zeus Panda intercepts the traffic of an Internet browser and modifies the content of websites displayed in the browser to steal credentials and other sensitive information. It targets numerous countries around the world, but exempts Russia, Ukraine, Belarus, and Kazakhstan. Some variants employed geo-filtering to specifically target Australia and UK banks.

Heodo was discovered in 2017. It primarily steals sensitive information like passwords and e-banking information. The infection is triggered with a user clicks on a link or opens a PDF file for a fake invoice that arrives in an email from a known contact.

QakBot is a sophisticated banking Trojan. When initially run, some versions, replace the original binary with a copy of the legitimate Windows Calculator application (i.e., calc.exe). It then uses multiple methods to check for the presence of virtualization software such as VirtualBox, CWSandbox, and VMware. These methods include: (i) checking installed programs; (ii) comparing process names to a predefined blacklist; (iii) examining registry entries; and (iv) checking hardware information. QakBot also attempts to determine if it is in an analysis environment by checking if the executable has been renamed to a file name commonly used by researchers, such as mlwr smpl, sample, or artifact.exe. QakBot also checks the IP address and/or the connection speed of the infected machine before communicating with its C&C.

Kovter has evolved from police scareware to click fraud and then to ransomware. It is typically is introduced via attachments coming from macro-based malicious spam. Once the malicious attachment (e.g., a compromised Microsoft Office file) is opened, the malware is installed. As an evasion technique the Kovter executable (e.g., 371255.exe) uses a different size and md5. It also uses parameters. If the first parameter is a file name, the malware will encrypt the file; otherwise, it doesn't do anything.

Locky was released in 2016 and was spread through JavaScript code that was infected with encrypted DLL files. The malware requires the use of rundll32.exe (which is not typically available in a sandbox environment) to execute the DLL, thereby allowing the malware to remain undetected by sandboxing.

Nymaim is an advanced malware downloader which was first documented in 2013 with information steal and system profiling capabilities. For sandbox evasion it checks that specific environment variable exist and for a specific date Range.

In view of the foregoing, it can be seen that among other factors providing the appropriate command line parameters, providing expected DLLs, and/or performing suitable environmental emulation may be important to coaxing malware to reveal itself when being run in a sandbox environment.

In an embodiment, the sandbox service 102 classifies the file as being malware by detonating the sandbox-evading malware as a result of performing sandboxing on the file. This includes emulating an environment of the endpoint device 106 based on the contextual information. The emulation includes mirroring of the environment of endpoint device 106 based on the contextual information related to the file.

In an example, the sandbox-evading malware may not perform Dynamic Link Library (DLL) file side-loading attack unless a required executable file is available. In another example, the sandbox evading malware may not execute unless the malware is in a particular geography, determined from an IP address. Further, in an example the sandbox evading malware may check for presence of a specific username, a domain name, an environment variable with a specific value, and a command line parameter to prevent execution. In yet another example, the sandbox-evading malware may have an encrypted payload that cannot be decrypted without the correct environment.

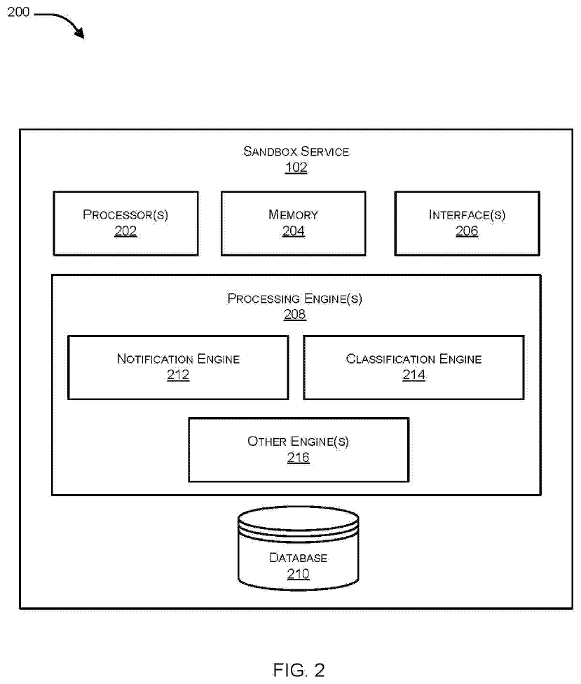

FIG. 2 is a block diagram 200 illustrating functional components of a sandbox service 102 in accordance with an embodiment of the present invention. In the context of the present example, sandbox service 102 can include one or more processor(s) 202. Processor(s) 202 can be implemented as one or more microprocessors, microcomputers, microcontrollers, digital signal processors, central processing units, logic circuitries, and/or any devices that manipulate data based on operational instructions. Among other capabilities, processor(s) 202 are configured to fetch and execute computer-readable instructions stored in a memory 204 of sandbox service 102. Memory 204 can store one or more computer-readable instructions or routines, which may be fetched and executed to create or share the data units over a network service. Memory 204 can include any non-transitory storage device including, for example, volatile memory such as RAM, or non-volatile memory such as EPROM, flash memory, and the like. In an example embodiment, memory 204 may be a local memory or may be located remotely, such as a server, a file server, a data server, and the Cloud.

Sandbox service 102 can also include one or more Interface(s) 206. Interface(s) 206 may include a variety of interfaces, for example, interfaces for data input and output devices, referred to as I/O devices, storage devices, and the like. Interface(s) 206 may facilitate communication of sandbox service 102 with various devices coupled to sandbox service 102. Interface(s) 206 may also provide a communication pathway for one or more components of sandbox service 102. Examples of such components include, but are not limited to, processing engine(s) 208 and database 210.

Processing engine(s) 208 can be implemented as a combination of hardware and software or firmware programming (for example, programmable instructions) to implement one or more functionalities of engine(s) 208. In the examples described herein, such combinations of hardware and software or firmware programming may be implemented in several different ways. For example, the programming for the engine(s) 208 may be processor executable instructions stored on a non-transitory machine-readable storage medium and the hardware for engine(s) 208 may include a processing resource (for example, one or more processors), to execute such instructions. In the examples, the machine-readable storage medium may store instructions that, when executed by the processing resource, implement engine(s) 208. In such examples, sandbox service 102 can include the machine-readable storage medium storing the instructions and the processing resource to execute the instructions, or the machine-readable storage medium may be separate but accessible to sandbox service 102 and the processing resource. In other examples, processing engine(s) 208 may be implemented by electronic circuitry. Database 210 can include data that is either stored or generated as a result of functionalities implemented by any of the components of processing engine(s) 208.

In an example, processing engine(s) 208 can include a notification engine 212, a classification engine 214 and other engine(s) 220. Other engine(s) 220 can implement functionalities that supplement applications or functions performed by sandbox service 102 or processing engine(s) 208.

According to an embodiment, notification engine 212 receives a file associated with sandbox-evading malware, and contextual information related to the file. The file is received from an endpoint security solution of a network security platform running on an endpoint device of an enterprise network. The contextual information related to the file may include command line information associated with the process, an execution chain associated with the process, a memory dump associated with the process, information indicative of an application with which the process is associated, information identifying an end user associated with the process, or environment variables associated with the process.

According to an embodiment, classification engine 214 classifies the file, associated with the sandbox-evading malware, as being malware by detonating the sandbox-evading malware as a result of performing sandboxing on the file including emulating an environment of the endpoint device based on the contextual information.

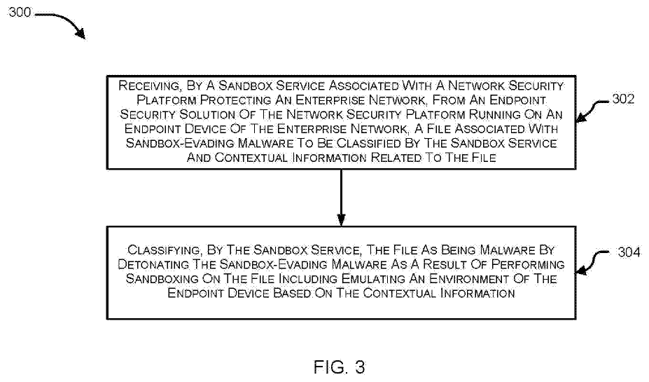

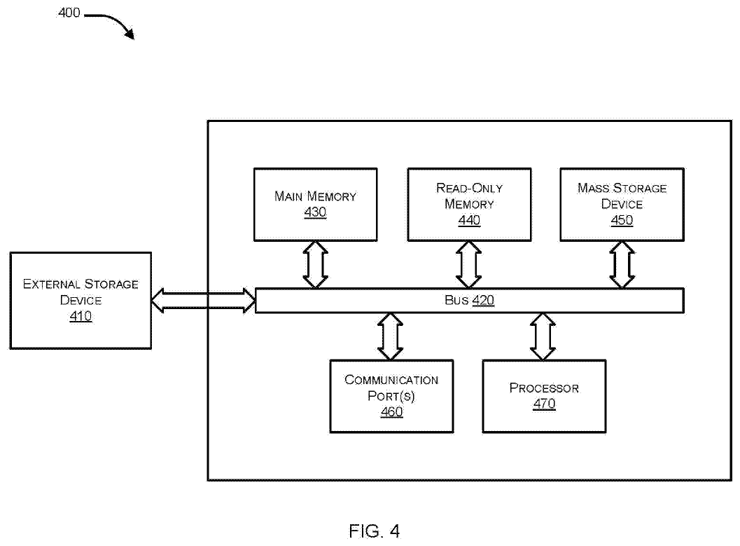

FIG. 3 is a flow diagram 300 illustrating a process performed by a sandbox service in accordance with an embodiment of the present invention. The processing described with reference to FIG. 3 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, this processing may be performed by a combination of one or more computer systems in physical or virtual form, such as computer system 400 described with reference to FIG. 4.

At block 302, a sandbox service (e.g. a physical or virtual sandbox appliance or a docker container) associated with a network security platform protecting an enterprise network, receives a file associated with sandbox-evading malware, to be classified by the sandbox service, and contextual information related to the file. The file is received from an endpoint security solution of the network security platform running on an endpoint device of the enterprise network.

At block 304, the file is classified as being malware by detonating the sandbox-evading malware as a result of performing sandboxing on the file including emulating an environment of the endpoint device based on the contextual information.

Embodiments of the present disclosure include various steps, which have been described above. A variety of these steps may be performed by hardware components or may be embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

FIG. 4 illustrates an exemplary computer system 400 in which or with which embodiments of the present invention may be utilized. For example, computer system 400 may represent an endpoint device (e.g., endpoint device 106), a server within a cloud-based security service (e.g., security platform 112) or a subset of computing resources associated with a sandbox service (e.g., sandbox service 102) or a network security appliance of a network security platform protecting a private network. While various examples described herein are described with reference to physical computer systems, those skilled in the art will appreciate the functionality and methodologies described herein are equally applicable to computing environments (e.g., a data center or cloud) in which functionality is deployed on virtual machines or as a service in the context of a container, a pod, or other virtualized environment. Furthermore, while in some embodiments, the various security event classification sources discussed herein have been described with reference to various security event classification services, it is to be appreciated that one or more of the various security event classification sources may be network security devices represented in virtual or physical form.

As shown in FIG. 4, computer system 400, includes an external storage device 410, a bus 420, a main memory 430, a read only memory 440, a mass storage device 450, a communication port 460, and a processor 470.

Those skilled in the art will appreciate that computer system 400 may include more than one processor 470 and communication ports 460. Examples of processor 470 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 470 may include various modules associated with embodiments of the present invention.

Communication port 460 can be any of an RS-232 port for use with a modem based dialup connection, a 10/100 Ethernet port, a Gigabit or 10 Gigabit port using copper or fiber, a serial port, a parallel port, or other existing or future ports. Communication port 460 may be chosen depending on a network, such a Local Area Network (LAN), Wide Area Network (WAN), or any network to which computer system connects.

Memory 430 can be Random Access Memory (RAM), or any other dynamic storage device commonly known in the art. Read only memory 440 can be any static storage device(s) e.g., but not limited to, a Programmable Read Only Memory (PROM) chips for storing static information e.g. start-up or BIOS instructions for processor 470.

Mass storage 450 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 420 communicatively couples processor(s) 470 with the other memory, storage and communication blocks. Bus 420 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 470 to software system.

Optionally, operator and administrative interfaces, e.g. a display, keyboard, and a cursor control device, may also be coupled to bus 420 to support direct operator interaction with computer system. Other operator and administrative interfaces can be provided through network connections connected through communication port 460. External storage device 410 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method comprising:
receiving, by a sandbox service associated with a network security platform protecting an enterprise network, from an endpoint security solution of the network security platform running on an endpoint device of the enterprise network, a file associated with sandbox-evading malware to be classified by the sandbox service and contextual information related to the file; and
classifying, by the sandbox service, the file as being malware by detonating the sandbox-evading malware as a result of performing sandboxing on the file including emulating an environment of the endpoint device based on the contextual information.

2. The method of claim 1, wherein the contextual information is captured by the endpoint security solution responsive to detection of a suspicious or malicious event detected by the endpoint security solution that relates to a process running on the endpoint device that is associated with the file.

3. The method of claim 2, wherein the contextual information includes:
command line information associated with the process;
an execution chain associated with the process;
information indicative of an application with which the process is associated;
operating system version;
file name and path;
loaded dynamic linked library (DLL) files and respective names and paths;
network domain name;
original geo-location and time-zone;
information identifying an end user associated with the process; or
environment variables associated with the process.

4. The method of claim 2, wherein the process being executed on the endpoint device is at least one of a file, a document, an application, an electronic mail, and an executable code.

5. The method of claim 1, wherein the emulation includes mirroring, by the sandbox service, of the environment of the endpoint device based on the contextual information related to the file.

6. The method of claim 1, wherein the network security platform is associated with a cloud-based security service.

7. The method of claim 1, wherein the sandbox service is in a form of a virtual sandbox appliance.

8. A non-transitory computer-readable storage medium embodying a set of instructions, which when executed by one or more processing resources associated with a sandbox service associated with a network security platform protecting an enterprise network, causes the one or more processing resources to perform a method comprising:
receiving, by a sandbox service associated with a network security platform protecting an enterprise network, from an endpoint security solution of the network security platform running on an endpoint device of the enterprise network, a file associated with sandbox-evading malware to be classified by the sandbox service and contextual information related to the file; and
classifying, by the sandbox service, the file as being malware by detonating the sandbox-evading malware as a result of performing sandboxing on the file including emulating an environment of the endpoint device based on the contextual information.

9. The non-transitory computer-readable storage medium of claim 8, wherein the contextual information is captured by the endpoint security solution responsive to detection of a suspicious or malicious event detected by the endpoint security solution that relates to a process running on the endpoint device that is associated with the file.

10. The non-transitory computer-readable storage medium of claim 9, wherein the contextual information includes:
command line information associated with the process;
an execution chain associated with the process;
a memory dump associated with the process;
information indicative of an application with which the process is associated;
information identifying an end user associated with the process; or
environment variables associated with the process.

11. The non-transitory computer-readable storage medium of claim 9, wherein the process being executed on the endpoint device is at least one of a file, a document, an application, an electronic mail, and an executable code.

12. The non-transitory computer-readable storage medium of claim 8, wherein the emulation includes mirroring, by the sandbox service, of the environment of the endpoint device based on the contextual information related to the file.

13. The non-transitory computer-readable storage medium of claim 8, wherein the network security platform is associated with a cloud-based security service.

14. The non-transitory computer-readable storage medium of claim 8, wherein the sandbox service is in a form of a virtual sandbox appliance.
